(19) United States
(12) Patent Application Publication
(10) Pub. No.: US 2015/0105536 A1
(43) Pub. Date: Apr. 16, 2015

(54) OBTAINING PRODUCTS FROM FEEDSTOCKS CONTAINING TOXIC ALGAE

(71) Applicant: Stephanie Ann Smith, Columbus, OH (US)

(72) Inventor: Stephanie Ann Smith, Columbus, OH (US)

(73) Assignee: BEAGLE BIOPRODUCTS, INC., Columbus, OH (US)

(21) Appl. No.: 14/511,510

(22) Filed: Oct. 10, 2014

Related U.S. Application Data
(60) Provisional application No. 61/889,349, filed on Oct. 10, 2013.

(51) Int. Cl. B01D 11/02; B01D 11/04

(52) U.S. Cl. CPC B01D 11/0288; B01D 11/0492
USPC 530/350; 422/119

(57) ABSTRACT

Systems, methods, and other embodiments are described herein for obtaining products from heterogeneous feedstocks containing toxic algae. In one embodiment, a method includes collecting a heterogeneous feedstock. The heterogeneous feedstock is then processed. The embodiment further includes calculating a toxic value for the processed heterogeneous feedstock. It is then determined whether the toxic value of the processed heterogeneous feedstock satisfies a toxic threshold. In response to determining the toxic value does satisfy the toxic threshold, a product is extracted from the heterogeneous feedstock.

### CROSS REFERENCE TO RELATED APPLICATION

This patent application claims the benefit of U.S. Provisional Application Ser. No. 61/889,349 filed on Oct. 10, 2013, which is hereby wholly incorporated by reference.

### BACKGROUND

Algae, including cyanobacteria that have been called “blue-green algae,” are a diverse group of aquatic microorganisms that play significant roles in aquatic ecology. In most aquatic food webs algae are the primary producers that support the higher trophic levels in a system. In spite of this fundamental role in the structure of an aquatic system, some algae may be harmful. Harmful algae may produce toxins that can threaten the health of animals and humans. For example, cyanobacteria have been well-characterized for their toxic properties, which have prevented them from historically being exploited for uses such as food, cosmetics, chemicals or pharmaceuticals where any risk of toxin contamination is unacceptable.

Under certain conditions related to nutrition, temperature, and other factors of environment, algae may undergo a rapid increase in population, referred to as an algae bloom. An algae bloom may be an assemblage of many types of algae, phytoplankton and bacteria, for example. When toxic algae are a component of that population, the overgrowth may be referred to as a harmful algae bloom (HAB). An HAB can have multiple “harmful” outcomes. The toxic algae can release toxins into the water, posing threats to animal and human health. Further, when the algae die, they are degraded by heterotrophic bacteria that consume oxygen during the degradation process. Due to the sheer volume of the algal biomass degraded, the system can become depleted of oxygen, leading to the death of plant and animal life. HABs are thus considered an ecological disaster in addition to a threat to human health.

Regardless of the toxic algae included in a biomass, some fraction of the non-toxic algae may be able to be used in applications such as food, cosmetics, chemicals, or pharmaceuticals. The non-toxic portion of the biomass is relevant because whether the biomass contains a high fraction of toxic algae or not, the amount of algal biomass may be beyond what can be easily obtained in laboratories or constructed growth systems, which is where large quantities of algae are typically grown. Thus, obtaining a biomass despite the fraction of toxic algae may be useful if the toxic algae could be separated from the biomass.

### BRIEF DESCRIPTION

This brief description is provided to introduce a selection of concepts in a simplified form that are described below in the detailed description. This brief description is not intended to be an extensive overview of the claimed subject matter, identify key factors or essential features of the claimed subject matter, nor is it intended to be used to limit the scope of the claimed subject matter.

A feedstock, or heterogeneous feedstock as referred to herein, refers to biological material, sometimes termed “biomass,” that has been produced or collected, and which contains or is expected to contain the products and co-products of interest. Specifically, feedstocks may contain blue-green algae, eukaryotic algae, or diatoms that produce toxins. These toxin-producing organisms are hereafter collectively referred to as “toxic algae.” Feedstocks containing toxic algae are may be generated through laboratory-based culturing of the organisms, natural bodies of water, water treatment facilities, or commercial processes where biomass containing toxic algae is collected. In addition to toxic algae, a feedstock may contain algae that do not produce toxins, other aquatic organisms, inorganic silts, sediments, coagulants, flocculants, or organic matter such as biological debris.

Described herein are examples of systems, methods, and other embodiments associated with obtaining products from a heterogeneous feedstock containing toxic algae. The systems, methods, and other embodiments described herein include collecting a heterogeneous feedstock that contain toxic algae. For example, indicative of toxic algae may be the presence of blue-green algae that are known to produce toxins, the presence of DNA sequences that are known to be associated with the biosynthesis of toxins in blue-green algae, or the presence of algal toxins. As discussed herein, the genera of blue-green algae may include but are not limited to Microcystis, Anabaena, Lyngbya, Cylindrospermopsis, Nodularia, and Aphanizomenon. DNA sequences, as discussed herein, may include but are not limited to sequences from the genes mycE and nadF. Likewise, as discussed herein, algal toxins may include but are not limited to microcystins, cylindrospermopsin, anatoxin, saxitoxin, and nodularin. The presence or amount of these toxins may be used to calculate a toxic value for the heterogeneous feedstock that can then be compared to a toxic threshold to determine if the heterogeneous feedstock has been processed to generate a product.

Specifically, a collected heterogeneous feedstock can be used to generate multiple final products through a number of processes. A process may be used alone or in conjunction with other processes. The amount and/or type of processes, alone or in combination, will be collectively referred to herein as biorefining. In one example, biorefining may include, but is not limited to, removal of part of the water from the heterogeneous feedstock. Biorefining may additionally or alternatively include the generation of extracts from the heterogeneous feedstock via physical processes. The physical processes may use solvents, physical and chromatographic separations of molecules based upon differences in their sizes or chemical properties, and so on.

The biorefining reduces the amount of toxic algae in non-toxic constituents of the biorefined heterogeneous feedstock. To determine if the amount of toxic algae, quantified as a toxic level, has been reduced to an acceptable amount, the toxic level is compared to a predetermined toxic threshold. To determine whether the toxic value satisfies a toxic threshold, the toxic value may be compared to the toxic threshold. In one embodiment, the toxic value is compared to the toxic threshold to determine whether the toxic value is less than or equal to the toxic threshold. In the event that the toxic level of the non-toxic constituent is less than the toxic threshold, the toxic threshold is deemed to be within tolerances defined for a specific product. If the toxic level of the non-toxic constituent is more than the toxic threshold, the non-toxic constituent is subjected to further biorefinement.

The following description and drawings set forth certain illustrative aspects and implementations. These are indicative of but a few of the various ways in which one or more aspects may be employed. Other aspects, advantages, or novel features of the disclosure will become apparent from the following detailed description when considered in conjunction with the drawings.

### BRIEF DESCRIPTION OF THE DRAWINGS

The accompanying drawings, which are incorporated in and constitute a part of the specification, illustrate various systems, methods, and other embodiments of the disclosure. Illustrated element boundaries (e.g., boxes, groups of boxes, or other shapes) in the figures represent one example of the boundaries. In some examples one element may be designed as multiple elements or multiple elements may be designed as one element. In some examples, an element shown as an internal component of another element may be implemented as an external component and vice versa.

FIG. 1 illustrates one embodiment of a method associated with obtaining products from feedstocks containing toxic algae.

FIG. 2 illustrates one embodiment of a method associated with obtaining products from feedstocks containing toxic algae.

FIG. 3 illustrates one embodiment of a method associated with obtaining products from feedstocks containing toxic algae.

FIG. 4 illustrates one embodiment of a system associated with obtaining products from feedstocks containing toxic algae.

FIG. 5 illustrates one embodiment of an example computer environment associated with obtaining products from feedstocks containing toxic algae.

### DETAILED DESCRIPTION

Embodiments or examples, illustrated in the drawings are disclosed below using specific language. It will nevertheless be understood that the embodiments or examples are not intended to be limiting. Any alterations and modifications in the disclosed embodiments, and any further applications of the principles disclosed in this document are contemplated as would normally occur to one of ordinary skill in the pertinent art. Described herein are examples of systems, methods, and other embodiments associated with obtaining products from feedstocks containing toxic algae.

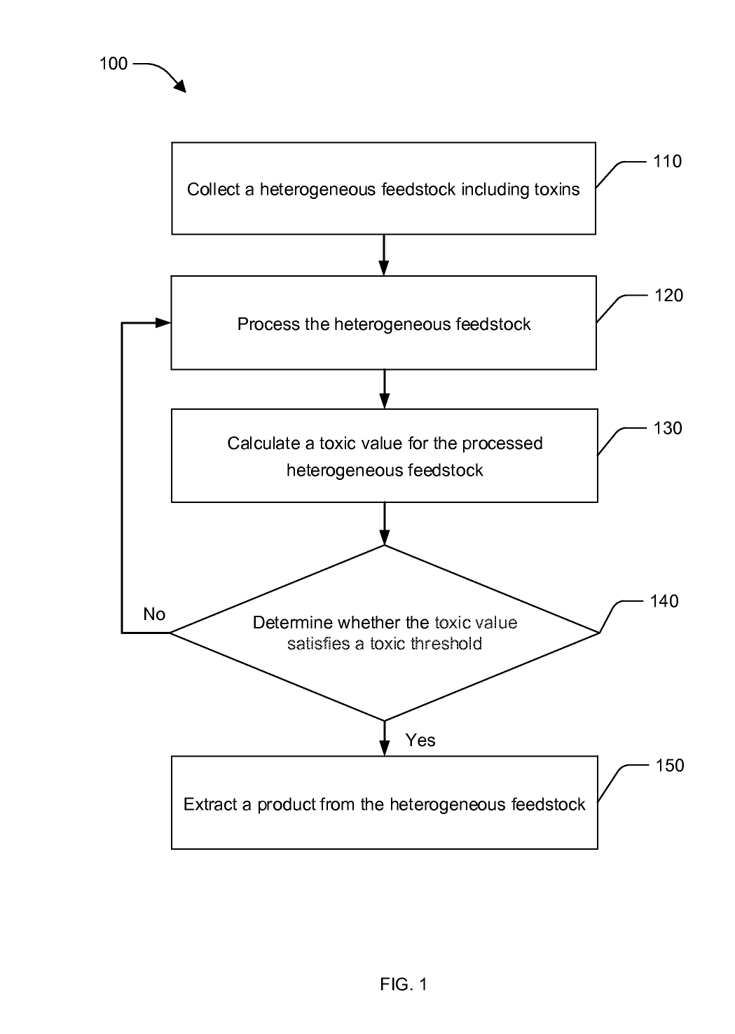

FIG. 1 is an illustration of an example method associated with obtaining products from feedstocks containing toxic algae. At 110, a heterogeneous feedstock having toxins is collected. As discussed above, the heterogeneous feedstock contains toxic algae. The heterogeneous feedstock may be collected from natural bodies of water such as standing water, bays, harbors, and/or lakes. Alternatively, the heterogeneous feedstock may be collected from a facility that processes large amounts of water, such as a water treatment plant. In an embodiment in which the heterogeneous feedstock is collected from a facility, the collection may utilize the infrastructure (e.g., vats, tubes, filtration systems) of the facility. In another embodiment, heterogeneous feedstocks containing algae, including toxic algae, may also be generated through culturing and artificial growth systems. A heterogeneous feedstock may then be collected from the generated heterogeneous feedstock. In the process described here, biomasses originating from these alternative sources, including a HAB, may comprise the heterogeneous feedstock.

At 120, the heterogeneous feedstock undergoes processing. In one embodiment, processing includes separating the heterogeneous feedstock into its constituent parts. For example, the heterogeneous feedstock is separated into liquids and solids. In this example, the liquid may be water in which the solids, including non-toxic and toxic algae, are suspended. In one embodiment, the liquid of the heterogeneous feedstock is extracted until the remaining heterogeneous feedstock is a predetermined percentage solids. While separating the heterogeneous feedstock into liquid and solid constituent parts is given as an example, other differentiating characteristics such as size, hydrophobia, etc.

In one embodiment, the processing includes separating the constituents of the heterogeneous feedstock using techniques such as freezing and thawing, use of centrifuges, chromatographic separation, size-exclusion separations, or hydrophobic separations. These are listed as example techniques; different techniques may be used to separate the constituent of the heterogeneous feedstock. Alternatively, the techniques may be used in conjunction with one another. Any process step may require specific conditions, such as temperature, pressure, and pH, to yield the desired Outputs. Modification of such conditions may in fact enhance the recovery of some Outputs relative to others. Further, the overall biorefining process is not restricted to any specific volumes or scale of operation, and in fact recognizes that at different scales minor modifications to the basic process steps may be required.

At 130, a toxic value is calculated for the processed heterogeneous feedstock. The processes may be collectively referred to as biorefining. The toxic value indicates the levels of the toxins remaining in the processed heterogeneous feedstock. For example, suppose that the processing isolates a liquid constituent of the heterogeneous feedstock. The liquid constituent may include a mixture of elements such as toxic algae and non-toxic algae. In one embodiment, the calculation is based on an amount of toxins by weight or alternatively calculation of percentages by the constituent.

At 140, it is then determined whether the toxic value satisfies a toxic threshold. Satisfying the toxic threshold may be defined as the toxic value exceeding a toxic threshold. Alternatively, satisfying the toxic threshold may be defined as the toxic value being within a range of values defined by the toxic threshold. In another embodiment, satisfying the toxic threshold may be defined as a toxic value being less than the toxic threshold. Thus, the toxic threshold and the definition of satisfying the toxic threshold can be tailored to the product or the application of the product being obtained from the heterogeneous feedstock.

Accordingly, the toxic threshold is a value of purity for the heterogeneous feedstock. For example, a consumer wishing to purchase a non-toxic constituent of the heterogeneous feedstock may have a specified tolerance for toxins in the non-toxic constituent. The tolerance is reflected in the toxic threshold. To determine whether the toxic value satisfies a toxic threshold, the toxic value may be compared to the toxic threshold.

In response to determining that the toxic value of the heterogeneous feedstock does not satisfy the toxic threshold at 140, the method 100 returns to 120 for further processing. Accordingly, the method 100 continues to process the feedstock until the toxic value of the heterogeneous feedstock satisfies the toxic threshold. In response to determining that the toxic value of the heterogeneous feedstock satisfies the toxic threshold at 140, the method continues to 150, and the heterogeneous feedstock is extracted for use as a product or co-product. In this manner, a product is extracted from the heterogeneous feedstock.

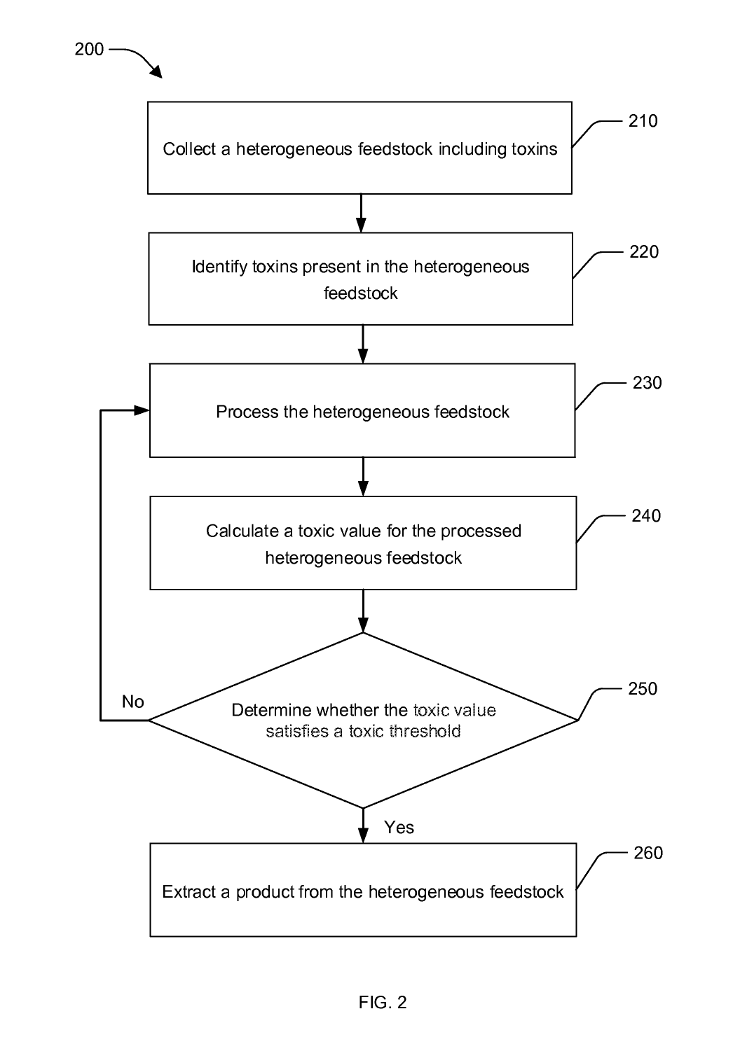

FIG. 2 is an illustration of an example method associated with obtaining products from feedstocks containing toxic algae. Steps 210 and 230-260 correspond to steps 110-150 of FIG. 1 and are performed in a similar manner. At 210, consider that a heterogeneous feedstock is collected. Specifically, the heterogeneous feedstock may be an algal biomass collected a harmful algae bloom (HAB). At 220, toxins in the heterogeneous feedstock are identified. For example, the heterogeneous feedstock may contain the toxin microcystin. Toxins in the heterogeneous feedstock may be identified using an enzyme-linked immunosorbent assay (ELISA) for this toxin. The toxins are identified so that an appropriate processing technique for the

At 230, the heterogeneous feedstock is processed into multiple products. For example, as discussed above, water may be separated from the heterogeneous feedstock. As discussed above the processing may be based on which toxins are identified in the heterogeneous feedstock. In one embodiment, the heterogeneous feedstock may be processed to isolate a solid constituent. The solid constituent may be processed until the heterogeneous feedstock has a solids content of approximately 12%. Processing the heterogeneous feedstock is not limited to a single type of processing. Instead, multiple processing techniques may be utilized. For example, in addition to isolating the constituent parts of the heterogeneous feedstock, the dewatered heterogeneous feedstock may be subject to further processing such as being subjected to freeze/thaw cycles.

As discussed above, the further processing included at 230 includes physical extraction that is performed through repeated cycles of thawing and freezing the heterogeneous feedstock. In one embodiment, five cycles of thawing and freezing may be performed. After a final thaw, cheesecloth may be used to remove large solids, which are set aside. The liquid stream that had passed through the cheesecloth is subjected to a first low-speed centrifugation, at approximately 3500×g. The liquid supernatant from the first low-speed centrifugation is set aside, and the solids are combined with the large solids that have been separated out with the cheesecloth. The combined solids were washed with an equal volume of water and subjected to a second low-speed centrifugation. The liquid supernatant from this second low-speed centrifugation step is combined with the liquid supernatant from the first centrifugation step, and the combined liquid supernatants is referred to as the “water extract.” The solids from the second low-speed centrifugation are referred to as the “total solids.”

Accordingly, the water extract and the total solids may be treated differently during the processing step 230. For example, the total solids may be subjected to a chemical extraction using acetone. In this case, the volume of the total solids is estimated, and acetone is added so that the final concentration of acetone would be 90% by volume. The mixture of total solids and acetone may then be further processed. For example, the mixture of total solids and acetone may be placed on ice and stirred for one hour. The total solids are separated from the mixture using filtration, and are discarded. The liquid output after filtration is referred to as the “acetone extract.”

Conversely, the water extract may undergo a different processing. For example, the water extract may be further separated into a “TFF filtrate” and a “TFF retentate” using tangential flow filtration (“TFF”) with a 10 kDa membrane. The TFF filtrate would be presumed to contain molecules that were less than 10 kDa in size, while the TFF retentate would contain molecules that were larger than 10 kDa.

The TFF filtrate is loaded onto a silica-based C18 flash chromatography column. All of the liquid that passes through the column during loading of the TFF filtrated is called the “C18 column flowthrough,” and the C18 column flowthrough,” is collected and set aside. Molecules that had bound to the column are released from the column by applying a solution containing methanol, and the liquid that came from the column was collected and called the “C18 column eluate.”

From the processing of the heterogeneous feedstock into total solids and water extract, and then further processing the total solids and water extract there are four resulting components. A toxic value is calculated for the four resulting components is calculated at 240. At 250, the toxic value is compared to a toxic threshold to determine if the toxic value satisfies the toxic threshold. If it is determined that the toxic value does not satisfy the toxic threshold at 250, the method 200 returns to 230 for further processing. Accordingly, the method 200 continues to process the feedstock until the toxic value of the heterogeneous feedstock satisfies the toxic threshold.

For example, the four components may be further processed in order to achieve a toxic value within the toxic threshold to a final product. These four components were the acetone extract, the TFF retentate, the C18 column flowthrough, and the C18 column eluate. Each of these components may be subjected to additional processing steps to ultimately yield at least four products. For example, the acetone extract was used to make a product called a chlorophyll calibrator, which could be used to calibrate a portable fluorometer used to measure the pigment chlorophyll in liquids. The TFF retentate may be used to make a product called a phycocyanin calibrator, which could be used to calibrate a portable fluorometer used to measure the pigment phycocyanin in liquids. The C18 column flowthrough may be used to generate a product that is an enriched preparation of mycosporine amino acids (“MAAs”), and which may be used in the formulation of cosmetics. Finally the C18 eluate may be further refined into product called a microcystin reference standard, which was a highly purified preparation of the toxin microcystin.

Thus, the four components receive further processing at 230. At 240, toxic values are calculated for the further processed four components. In response to determining that the toxic value of the four components satisfies the toxic threshold at 250, the method 200 continues to 260, and the four components are extracted for use as a product or co-product. Accordingly, the components may continue to undergo processing until the toxic value of the processed component satisfies

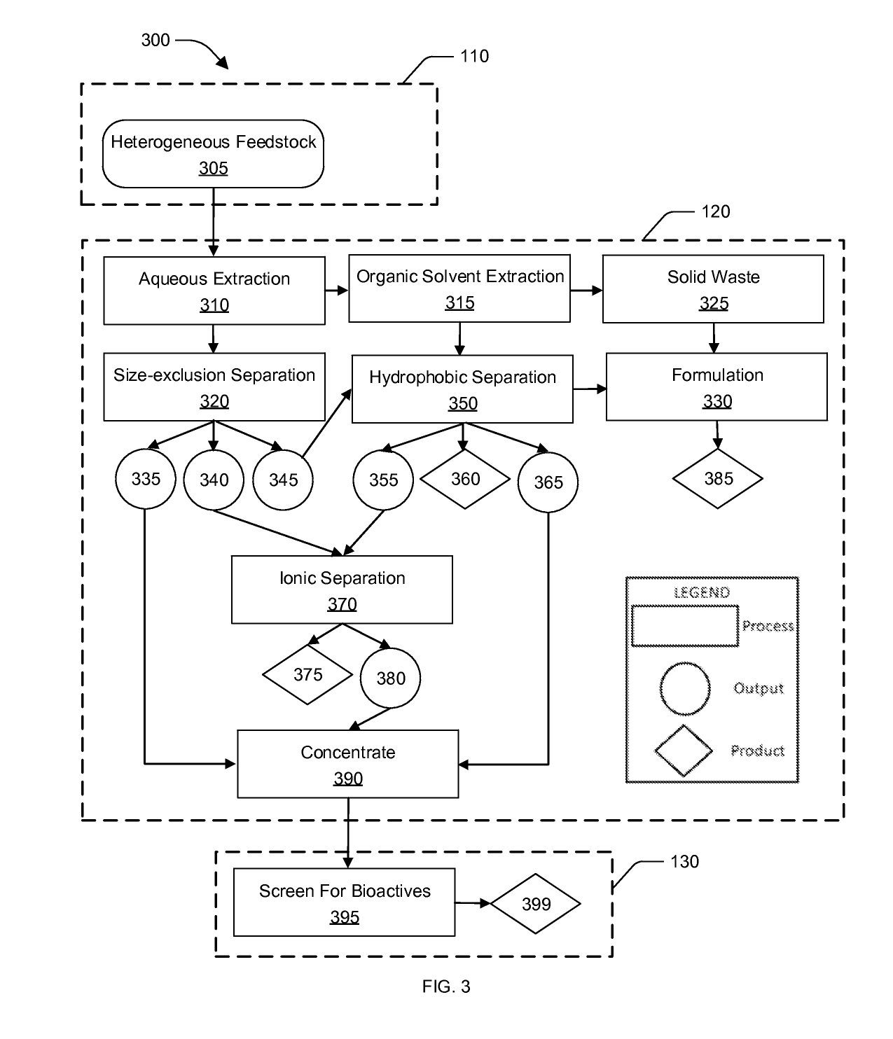

FIG. 3 is an illustration of an example associated with obtaining products from feedstocks containing toxic algae. Specifically, FIG. 3 further illustrates the processing of a heterogeneous feedstock as described with respect to FIG. 2. Specifically, as shown in the Legend of FIG. 3, rectangles represent process steps. A process step may have multiple actions which are not shown in detail here. For example, it is not shown that Aqueous Extraction may include the subprocesses of freezing and thawing, stirring the material overnight, or the control of temperature. Of import here is the understanding of the main function of the process steps. Circles in FIG. 3 represent the outputs of process steps, and may take many forms. For example, these outputs may take the form of a constituent collected from a chromatographic separation, or a precipitate collected from a salt precipitation. Diamonds in FIG. 3 represent products, meaning that these are some of the final products of the biorefining process and are not expected to undergo any further biochemical processing. Like the rectangles representing processes, the diamonds may have inherent steps that are not detailed here, but which are understood to be necessary in order to attain the purity that is required for the product's final application. Multiple combinations of processes that may be derived from the example procedure disclosed herein and illustrated in FIG. 3.

To clarify the manner in which FIG. 3 corresponds to previously described methods, the dashed boxes shown in FIG. 3 represent steps of the method 100. Specifically, the elements of FIG. 3 are organized to be contained by a dashed box 110, 120, or 130 to identify the elements contributing to the collection of a heterogeneous feedstock as described with respect to 110, processing the heterogeneous feedstock as described with respect to 120, or calculating the toxic value as described with respect to 130 in FIG. 1. The remaining steps of method 100 not assigned elements in FIG. 3 operate in the manner described with respect to FIG. 1.

A heterogeneous feedstock is collected at 305. The heterogeneous feedstock contains the toxic algae at least in part of its composition. The heterogeneous feedstock undergoes aqueous extraction at 310. The heterogeneous feedstock undergoes aqueous extraction 310 because the heterogeneous feedstock may be in a water medium when it is collected. Aqueous extraction 310 may take the form of freeze/thaw cycles to initiate extraction.

As discussed above, the heterogeneous feedstock is separated into constituents. In the embodiment illustrated in FIG. 3, the collected heterogeneous feedstock is undergoes two processes. Specifically, organic solvent extraction at 315 and size exclusion separation at 320. Material may be separated via centrifugation or alternatives into liquid and solid constituent that are carried through the rest of the process steps. Liquid constituents are sometimes termed “crude extracts,” and because they are liquid are generally suitable for chromatographic separations. Solid constituent will typically undergo further extraction for the recovery of products. Solid constituent may be considered Solid Waste 325 if no further extraction is anticipated. This waste may be formulated 330 into a final product, because it has the potential to still be rich in chemicals that have value in some applications.

Size-exclusion separations 320 can be performed to separate the molecules from an extraction Aqueous Extraction 310 into outputs 335, 340, and 345, on the basis of size. While three outputs 335, 340, and 345 are shown here, the size exclusion separation 320 may have more or fewer outputs. Outputs of the 335 type may be termed “flowthrough,” and are size classes of molecules that are not of interest as final products. Outputs of types 340 and 345 are of desired size classes, but will require further purification to separate the desired from the undesired molecules of that size class. Types of outputs 340 and 345 thus proceed to other separation steps.

Hydrophobic Separation 350 represents processes that separate molecules on the basis of their polarity relative to water. There are three types of outputs, 355, 360, and 365. Output 365 could be termed “flowthrough,” and includes molecules that do not behave with the polarity that is expected of the desired final products. Output 360 is in a diamond shape because output 360 is a desired product. Accordingly, outputs at this stage of processing may be desired products. However, outputs are not necessarily products. For example, output 355 contains desired products that require further separations, such as on the basis of molecule charge. Output 355 undergoes Ionic Separation 370.

Ionic Separation 370 represents processes that separate molecules based on the separate molecules' charges, such as whether they are cationic or anionic. Two likely outputs of Ionic Separation 370 include desired product 375 and another “flowthrough” output 380. The separation steps represented by Size-exclusion Separation 320, Hydrophobic Separation 350, and Ionic Separation 370 are interchangeable with respect to their sequence relative to one another. Size-exclusion Separation 320, Hydrophobic Separation 350, and Ionic Separation 370 may or may not require any or all of these separation steps. The processing steps included in the processing of the heterogeneous feedstock are flexible.

Centrifugation can be used to separate the liquids and the solids. The liquid material can undergo gel filtration chromatography as in Size-exclusion Separation 320 that will trap all molecules that are under 100 kDa, but which will allow all larger molecules to pass through as Output 355. As the molecules of interest are eluted from the column, some of them may undergo cation exchange chromatography as in Ionic Separation 370, and others may be segregated for reverse-phase high-pressure liquid chromatography as in Hydrophobic Separation 350.

Examples of Output 375 are phycocyanin, a pigment common in toxic cyanobacteria, and microcystin, a toxin common in some cyanobacteria. An example of Output 360 is mycosporine amino acids, and an example of Output 385 is fertilizer pellets. The flowthrough Outputs 335, 365, and 380 may undergo buffer exchanges so that they can be Concentrate 390 and combined, and used collectively to Screen for Bioactive molecules 395. Screening can involve a mammalian cell-based assay that identifies compounds that induce apoptosis, for example.

At Concentrate 390 the flowthrough materials Outputs 335, 365, and 380 may be appropriately concentrated in order to be used for Screening for Bioactives 395. Concentrate 390 can also entail buffer exchanges to get the molecules into an aqueous medium that is appropriate for the Screening for Bioactives 395. Screening for Bioactives 395 may entail a number of bioassays for specific desired activities of molecules found in the concentrate. Output 399 represents any possible molecules or mixtures of molecules that are found through Screening to have a desired activity.

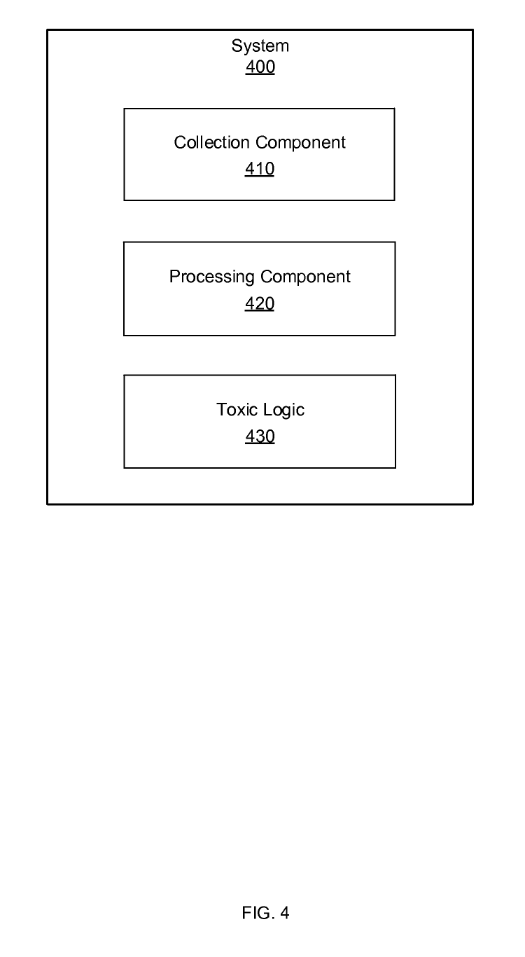

FIG. 4 illustrates one embodiment of a system associated with obtaining products from feedstocks containing toxic algae. The system 400 includes a collection component 410, a processing component 420, and a toxic logic 430. The collection component 410 collects a heterogeneous feedstock containing toxins. As discussed above, the heterogeneous feedstock may be collected from natural bodies of water such as standing water, bays, harbors, and/or lakes or facilities that processes large amounts of water, such as a water treatment plant. The collection component 410 may store the collected heterogeneous feedstock.

The processing component 420 processes the collected heterogeneous feedstock. As discussed above, the heterogeneous feedstock may be processed into its constituent parts. For example, the heterogeneous feedstock is separated into liquids and solids. Accordingly, the processing component 420 may be configured to use techniques such as freezing and thawing, use of centrifuges, chromatographic separation, size-exclusion separations, or hydrophobic separations. These are listed as example processes capable of being carried out but the processing component 420.

The processing component 420 may carry out a single or multiple processes. Furthermore, the processing component may carry out multiple processes serially or in parallel. For example, suppose that the heterogeneous feedstock has been separated into two constituents. The processing component 420 may carry out a first set of processes on one of the constituents and a second set of processes on the remaining constituent. In this manner the processing component may process multiple constituents of the heterogeneous feedstock.

The toxic logic 430 calculates at least one toxic value for the processed heterogeneous feedstock. Thus, if multiple constituents have been processed from the heterogeneous feedstock, a toxic value may be calculated for one or more of the constituents. In one embodiment, if a constituent is being processed to produce a product, then the toxic logic 430 calculates a toxic value for the constituent. If the constituent is a byproduct of the processing, then the toxic logic may not calculate a toxic value of the constituent.

The toxic logic 430 uses the calculated toxic value to determine whether the toxic value satisfies a toxic threshold. As described above, satisfying the toxic threshold may be defined as the toxic value exceeding a toxic threshold. Alternatively, satisfying the toxic threshold may be defined as the toxic value being within a range of values defined by the toxic threshold. In another embodiment, satisfying the toxic threshold may be defined as a toxic value being less than the toxic threshold. Thus, the toxic threshold and the definition of satisfying the toxic threshold can be tailored to the product or the application of the product being obtained from the heterogeneous feedstock. The toxic logic 430 may compare the toxic value to the toxic threshold to determine whether the toxic value satisfies a toxic threshold.

In response to determining that the toxic value of the heterogeneous feedstock does not satisfy the toxic threshold, the toxic logic 430 generates an indicator and transmits the indicator to the processing component 420. The processing component 420 then commences further processing of the heterogeneous feedstock and/or the constituents of the heterogeneous feedstock. Once a predetermined set of at least one process has been performed by the processing component 420, the toxic logic may then again calculate a toxic value for the reprocessed heterogeneous feedstock and/or the constituents of the reprocessed heterogeneous feedstock. The recalculated toxic value can then be compared to the toxic threshold. Accordingly, heterogeneous feedstock and/or the constituents of the heterogeneous feedstock may continue to be processed by the processing component 420 until the toxic value of the heterogeneous feedstock satisfies the toxic threshold. In response to determining that the toxic value of the heterogeneous feedstock satisfies the toxic threshold, the heterogeneous feedstock is extracted for use as a product or co-product.

The systems, methods, and embodiments described herein eliminate costly steps on the front end of the typical processes by collecting HAB-enriched sludge from drinking water plants, rather than growing and harvesting cyanobacteria. Costs are reduced through the elimination of capital and operational expenditures, and water, nutrient and energy consumption associated with phototrophic growth. Modifications to the means by which these products are extracted and purified also result in a more sustainable, lower waste-generating manufacturing process. Moreover, plant operators that want to reduce their sludge and sludge disposal costs, and participate with a small business in the development of a novel waste-to-product strategy. As a result, microcystin toxin and the other products described above will be provided at commercially relevant scales that would not be technically feasible by solely growing cyanobacteria in the laboratory or even at pilot scale.

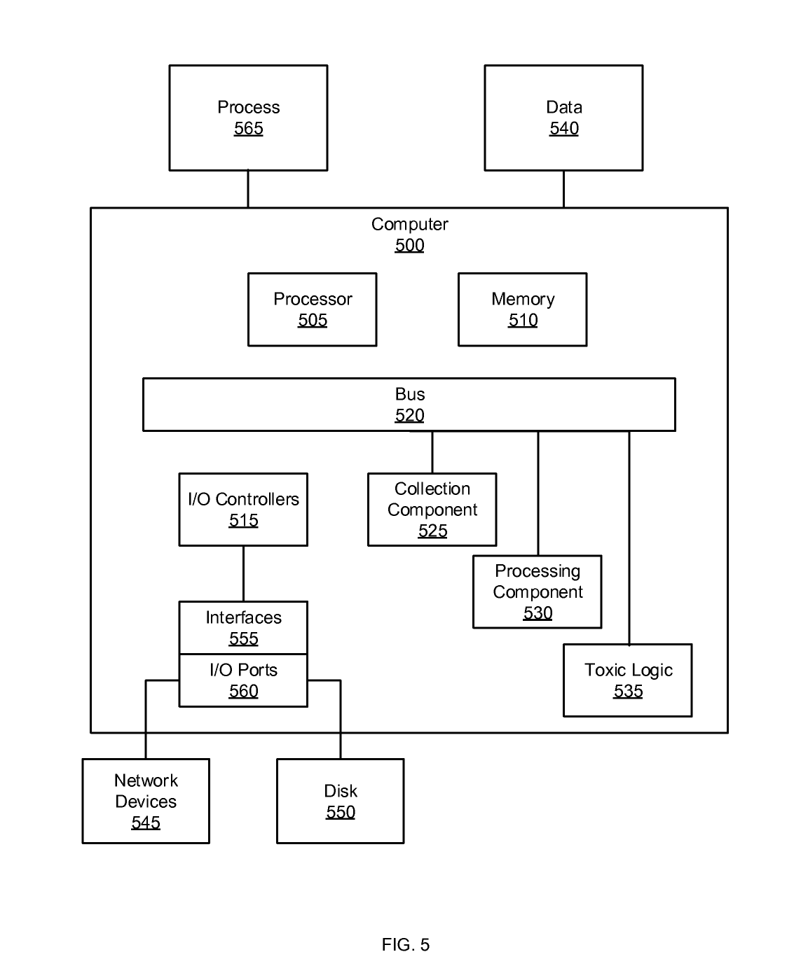

FIG. 5 illustrates one embodiment of an example computer environment associated with obtaining products from feedstocks containing toxic algae. The computer environment in which the systems and methods described herein, and equivalents, may operate may include a computer 500. The computer includes a processor 505, a memory 510, and input/output (I/O) ports 515 operably connected by a bus 520. In one example, the computer 500 may include a collection component 525, an processing component logic 530, and a toxic logic 535. The collection component 525 is configured to collect a heterogeneous feedstock. For example, the collection component 525 may be configured to collect a predetermined amount of heterogeneous feedstock. The processing component 530 is configured to process the heterogeneous feedstock. The toxic logic 535 is configured to calculate a toxic value and determine whether the toxic value satisfied a predetermined toxic threshold.

In different examples, the collection component 525, the processing component 530, and the toxic logic 535 may be implemented in hardware, a non-transitory computer-readable medium with stored instructions, firmware, and/or combinations thereof. While the collection component 525, the processing component 530, and the toxic logic 535 are illustrated as hardware components attached to the bus 520, it is to be appreciated that in one example, the collection component 525, the processing component 530, and the toxic logic 535 could be implemented in the processor 505. Moreover, an activity log accessed by the activity logic 530 may be stored in the memory 510.

In one embodiment, collection component 525 is a means (e.g., hardware, non-transitory computer-readable medium, firmware) for collecting a predetermined amount of heterogeneous feedstock. The processing component 530 is a means (e.g., hardware, non-transitory computer-readable medium, firmware) for performing one or more processes on the heterogeneous feedstock. The toxic logic 535 is a means (e.g., hardware, non-transitory computer-readable medium, firmware) for calculating a toxic value and determining whether the toxic value satisfied a predetermined toxic threshold. The means may be implemented, for example, as an application specific integrated circuit (ASIC) programmed to facilitate data editing in a web-based interactive web response system. The means may also be implemented as stored computer executable instructions that are presented to computer 500 as data 540 that are temporarily stored in memory 510 and then executed by processor 505.

Generally describing an example configuration of the computer 500, the processor 505 may be a variety of various processors including dual microprocessor and other multi-processor architectures. The memory 510 may include volatile memory and/or non-volatile memory. Non-volatile memory may include, for example, ROM, PROM, and so on. Volatile memory may include, for example, RAM, SRAM, DRAM, and so on.

Network device 545 and a disk 550 may be operably connected to the computer 500 via, for example, an I/O interfaces (e.g., card, device) 555 and an I/O ports 560. The disk 545 may be, for example, a magnetic disk drive, a solid state disk drive, a floppy disk drive, a tape drive, a Zip drive, a flash memory card, a memory stick, and so on. Furthermore, the disk 545 may be a CD-ROM drive, a CD-R drive, a CD-RW drive, a DVD ROM, and so on. The memory 510 can store data 540 and/or a process 565, for example. The disk 550 and/or the memory 510 can store an operating system that controls and allocates resources of the computer 500.

The bus 520 may be a single internal bus interconnect architecture and/or other bus or mesh architectures. While a single bus is illustrated, it is to be appreciated that the computer 500 may communicate with various devices, logics, and peripherals using other busses (e.g., PCIE, 1394, USB, Ethernet). The bus 520 can be types including, for example, a memory bus, a memory controller, a peripheral bus, an external bus, a crossbar switch, and/or a local bus.

The computer 500 may interact with I/O devices via the I/O interfaces 555 and the I/O ports 560. Input/output devices may be, for example, a keyboard, a microphone, a pointing and selection device, cameras, video cards, displays, the network devices 545, the disk 550, and so on. The I/O ports 560 may include, for example, serial ports, parallel ports, and USB ports.

The computer 500 can operate in a network environment and thus may be connected to the network devices 545 via the I/O interfaces 555, and/or the I/O ports 560. Through the network devices 545, the computer 500 may interact with a network. Through the network, the computer 500 may be logically connected to remote computers. Networks with which the computer 500 may interact include, but are not limited to, a LAN, a WAN, and other networks.

In another embodiment, the described methods and/or their equivalents may be implemented with computer executable instructions. Thus, in one embodiment, a non-transitory computer-readable medium is configured with stored computer executable instructions that when executed by a machine (e.g., processor, computer, and so on

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

As used in this application, the terms “component,” “module,” “system,” “interface,” and the like are generally intended to refer to a computer-related entity, either hardware, a combination of hardware and software, software, or software in execution. For example, a component may be, but is not limited to being, a process running on a processor, a processor, an object, an executable, a thread of execution, a program, or a computer. By way of illustration, both an application running on a controller and the controller may be a component. One or more components residing within a process or thread of execution and a component may be localized on one computer or distributed between two or more computers.

“Computer storage medium” as used herein is a non-transitory medium that stores instructions and/or data. A computer storage medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer storage media may include, but are not limited to, a floppy disk, a flexible disk, a hard disk, a magnetic tape, other magnetic medium, an ASIC, a CD, other optical medium, a RAM, a ROM, a memory chip or card, a memory stick, and other electronic media that can store computer instructions and/or data. Computer storage media described herein are limited to statutory subject matter under 35 U.S.C §101.

“Logic” as used herein includes a computer or electrical hardware component(s), firmware, a non-transitory computer storage medium that stores instructions, and/or combinations of these components configured to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions that when executed perform an algorithm, and so on. Logic may include one or more gates, combinations of gates, or other circuit components. Where multiple logics are described, it may be possible to incorporate the multiple logics into one physical logic component. Similarly, where a single logic unit is described, it may be possible to distribute that single logic unit between multiple physical logic components. Logic as described herein is limited to statutory subject matter under 35 U.S.C §101.

While for purposes of simplicity of explanation, illustrated methodologies are shown and described as a series of blocks. The methodologies are not limited by the order of the blocks as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional, not illustrated blocks. The methods described herein is limited to statutory subject matter under 35 U.S.C §101.

To the extent that the term “includes” or “including” is employed in the detailed description or the claims, it is intended to be inclusive in a manner similar to the term “comprising” as that term is interpreted when employed as a transitional word in a claim.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. §101.

What is claimed is:

1. A method, comprising:
collecting a heterogeneous feedstock;
processing the heterogeneous feedstock;
calculating a toxic value for the processed heterogeneous feedstock;
determining whether the toxic value for the processed heterogeneous feedstock satisfies a toxic threshold; and
in response to determining the toxic value does satisfy the toxic threshold, extracting a product from the processed heterogeneous feedstock.

2. The method of claim 1, wherein the processing comprises separating the heterogeneous feedstock into a liquid constituent and a solids constituent.

3. The method of claim 1, further comprising setting the toxic threshold, wherein the toxic threshold for the heterogeneous feedstock is based, at least in part, on a presence of genera of blue-green algae that produce toxins, on a presence of DNA sequences associated with production of toxins, or on the presence of toxins.

4. The method of claim 1, wherein in response to determining the toxic value does not satisfy the toxic threshold, further processing the processed heterogeneous feedstock.

5. The method of claim 1, wherein the product is a chlorophyll calibrator for portable fluorometers.

6. The method of claim 1, wherein the product is a phycocyanin calibrator for portable fluorometers.

7. The method of claim 1, wherein the product is an enriched preparation of mycosporine amino acids.

8. The method of claim 1, wherein the product is a microcystin reference standard.

9. A method of biorefining feedstocks including toxic algae to produce products comprising:
providing feedstock that at least in part comprises toxic algae;
extracting at least one solid constituent via aqueous extraction;
extracting at least one liquid constituent via organic solvent extraction; and
separating the at least one liquid constituent, wherein the separation produces a product.

10. The method of claim 9, further comprising extracting at least one solid constituent via the organic solvent extraction.

11. The method of claim 9, further comprising formulating a first product.

12. The method of claim 9, further comprising formulating a second product.

13. The method of claim 9, further comprising extracting at least one liquid constituent via the organic solvent extraction.

14. The method of claim 13, further comprising separating the at least one liquid constituent into a plurality of outputs via hydrophobic separation.

15. The method of claim 14, wherein the plurality of outputs includes at least another product.

16. The method of claim 13, further comprising separating the at least one liquid constituent into a plurality of outputs via size-exclusion separation.

17. A system, comprising:
a collection component configured to collect a predetermined amount of heterogeneous feedstock;
a processing component configured to process the collected heterogeneous feedstock; and
a toxic logic configured to:
(i) calculate a toxic value for the processed heterogeneous feedstock;
(ii) determine whether the toxic value for the processed heterogeneous feedstock satisfies a toxic threshold; and
(iii) in response to determining the toxic value does satisfy the toxic threshold, extract the heterogeneous feedstock.

18. The method of claim 17, wherein the processing component is configured to separate the heterogeneous feedstock into a liquid constituent and a solids constituent.

19. The method of claim 17, wherein in response to determining the toxic value does not satisfy the toxic threshold, the toxic logic is configured to:
(i) generate an indicator; and
(ii) transmit the indicator to the processing component.

20. The method of claim 19, wherein in response receiving the indicator, the processing component is configured to reprocess the processed heterogeneous feedstock.
